(19) United States
(12) Patent Application Publication
(10) Pub. No.: US 2026/0367902 A1
(43) Pub. Date: Nov. 19, 2026

(54) SMART NETWORK SELECTION FOR OPTIMIZED OTA UPDATE DELIVERY IN VEHICLES

(71) Applicant: American Honda Motor Co., Inc., Torrance, CA (US)

(72) Inventors: DANIEL MARK TIET, HUNTINGTON, CA (US); BONNIE CHEN HONG, TORRANCE, CA (US)

(21) Appl. No.: 19/212,448

(22) Filed: May 19, 2025

(51) Int. Cl. G06F 8/65; H04W 48/18; H04W 84/12

(52) U.S. Cl. CPC G06F 8/65; H04W 48/18; H04W 84/12

(57) ABSTRACT

The present disclosure describes a data management system and method for managing over-the-air (OTA) software updates and high-bandwidth data operations in a vehicle. The system may include a wireless communication module configured to interface with both cellular and wireless local area networks (WLAN), and a network selection engine that dynamically prioritizes the use of WLAN over cellular connections based on factors including update size, data size, historical data usage, and real-time network availability. A controller may defer the execution of selected vehicle software functions—such as updates, media downloads, or feature activations—until a preferred network connection is established in accordance with user-defined policies. The system also integrates a machine learning module that optimizes future download scheduling based on learned patterns of connectivity and usage.

### BACKGROUND

Current vehicles increasingly rely on over-the-air (OTA) updates to deliver essential software upgrades for vehicle systems, including infotainment, advanced driver-assistance systems (ADAS), navigation, and core operating firmware. These OTA mechanisms enable manufacturers to deploy new features, fix bugs, and enhance a user experience without requiring a physical service appointment. While OTA updates provide convenience and scalability, they also introduce challenges—particularly when large data files are transmitted over cellular networks such as 4G or 5G. Transferring significant volumes of data through mobile carriers may result in elevated operational costs for the vehicle manufacturer or the end user and may degrade network performance or exceed allocated data limits.

Existing vehicle telematics and network management systems typically operate on rigid or simplistic rules, such as defaulting to cellular networks when Wi-Fi is unavailable or indiscriminately allowing all functions regardless of connection quality. These systems generally lack mechanisms for dynamically selecting the most efficient or cost-effective data transmission channel based on multiple factors such as network availability, update size, data size, historical bandwidth usage, or user-configured policies. Additionally, current architectures do not support conditional restriction or deferral of high-data-consuming features until a preferred non-cellular connection is established. Consequently, there is a need for an intelligent data management framework that may optimize OTA update delivery and feature availability by selectively managing network interfaces in real-time.

### BRIEF DESCRIPTION

This summary is provided to introduce a selection of concepts in a simplified form that are further described below in the DESCRIPTION OF THE DISLCOSURE. This summary is not intended to identify key features of the claimed subject matter, nor is it intended to be used as an aid in determining the scope of the claimed subject matter.

In accordance with one aspect of the present disclosure, a data management system is provided. The system may include a wireless communication module configured to communicate over a cellular network and a wireless local area network (WLAN). In addition, the system may include a network selection engine detecting availability of one or more network connections, evaluating historical data usage and data size of one or more software functions, and dynamically prioritizing a use of the WLAN and cellular network for data transmission of the one or more software functions based on the evaluation. The system may include a controller deferring execution of the one or more software functions until a preferred network connection is established based on the prioritization.

In accordance with another aspect of the present disclosure, a method for managing over-the-air software updates is provided. The method may include detecting a software update available for download, determining a size of the software update and analyzing prior data usage history, and selecting a preferred network connection from among a set of available networks based on: user-defined policies, real-time network conditions, and the determined update or data size. In addition, the method may include postponing the download of the software update unless the preferred network connection is available.

In accordance with yet another aspect of the present disclosure, a computer-readable storage medium having instructions stored thereon is provided. The instructions, when executed by a processor, causes performance of operations. These operations may include monitoring for large data download or upload requests initiated by a system, evaluating whether a non-cellular network connection is currently active, restricting or suspending such data transfer operations when only cellular data is available, and enabling the data transfer upon establishment of a non-cellular connection.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a block diagram of an exemplary vehicle data management system including a wireless communication module, a network selection engine, and a controller, in accordance with one or more embodiments;

FIG. 2 is a flowchart illustrating a method for managing over-the-air (OTA) software updates using dynamic network prioritization based on update size, data size, network conditions, and user-defined preferences, in accordance with one or more embodiments;

FIG. 3 is a flowchart illustrating the operation of the controller in deferring vehicle software functions until a preferred network connection is available, in accordance with one or more embodiments;

FIG. 4 is a diagram of a user interface display allowing configuration of network usage policies for specific applications and features, in accordance with one or more embodiments;

FIG. 5 is a schematic view illustrating interaction between the vehicle, a cloud update server, and a mobile hotspot or Wi-Fi access point for managing data transmission, in accordance with one or more embodiments;

FIG. 6 is a diagram showing an example of network switching behavior and conditional download execution across multiple connectivity states (Wi-Fi, cellular, disconnected), in accordance with one or more embodiments; and

FIG. 7 is a block diagram illustrating integration of a machine learning module within the network selection engine to optimize future download scheduling based on historical patterns, in accordance with one or more embodiments.

### DESCRIPTION OF THE DISCLOSURE

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

This disclosure generally to over-the-air (OTA) update systems for vehicles and more specifically to systems and methods for intelligent selection of network channels for large data downloads or uploads, such as software and firmware updates. In an illustrative embodiment, a data management system and method for managing OTA software updates and high-bandwidth data operations in a vehicle is provided. The system may include a wireless communication module configured to interface with both cellular and wireless local area networks (WLAN), and a network selection engine that dynamically prioritizes the use of WLAN over cellular connections based on factors including update size, data size, historical data usage, and real-time network availability. A controller may defer the execution of selected vehicle software functions—such as updates, media downloads, or feature activations—until a preferred network connection is established in accordance with user-defined policies. The system also integrates a machine learning module that optimizes future download scheduling based on learned patterns of connectivity and usage.

Advantageously, and by combining intelligent network prioritization, configurable policies, and conditional execution of software features, the system and method reduces cellular data consumption, ensures timely delivery of essential updates, and enhances user control over vehicle data usage behavior. Other advantages will become apparent from the description provided below. Modifications and configurations to the illustration will become apparent from the following detailed description.

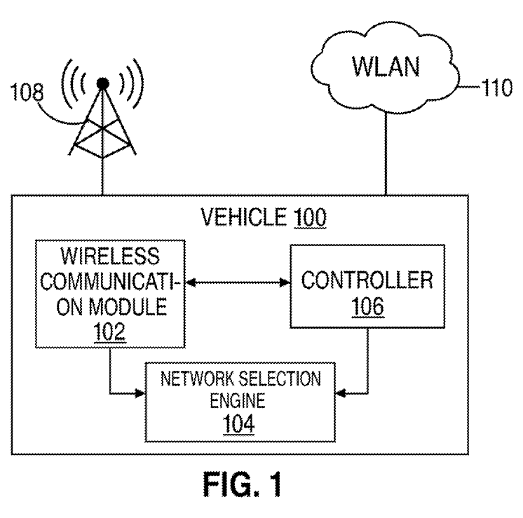

Turning to FIG. 1, a block diagram of an exemplary vehicle data management system including a wireless communication module 102, a network selection engine 104, and a controller 106 implemented within a vehicle 100 is provided. The system is designed to intelligently manage data transmission for software functions based on dynamic evaluation of network conditions, data size, and historical usage patterns. Fewer or more components may be used within the system.

The wireless communication module 102 may be configured to establish communication links with both a cellular network via a base station 108, and a wireless local area network (WLAN) 110, such as Wi-Fi. In one embodiment, the wireless communication module 102 includes multiple transceivers, each dedicated to a specific radio access technology (RAT), such as LTE/5G for cellular and IEEE 802.11 standards for WLAN. In another embodiment, the wireless communication module 102 may be implemented using a multi-mode modem capable of time-multiplexed or simultaneous operation across multiple network interfaces.

The module 102 may further include one or more antennas (internal or external), power amplifiers, and digital signal processing (DSP) units that handle encoding, modulation, filtering, and error correction of wireless signals. The antennas may support beamforming, MIMO (Multiple Input, Multiple Output), or diversity reception techniques to improve link robustness and throughput. In some implementations, the wireless communication module 102 may employ software-defined radio (SDR) techniques to flexibly adapt to evolving network standards or policies through firmware updates.

In some embodiments, the module 102 may be integrated with a vehicle telematics control unit (TCU) or electronic control unit (ECU) that includes network stacks and protocol handling software to manage session establishment, authentication, and failover between network types. For example, if the cellular signal strength degrades below a threshold, the system may automatically initiate a scan for available WLAN networks and attempt reconnection using saved credentials.

In another embodiment, the wireless communication module 102 may interface with vehicular gateway systems or head units, allowing integration with third-party infotainment apps or fleet management software. This enables remote diagnostics, geofencing-based connectivity rules, and context-aware data handling (e.g., pausing updates while the vehicle is in motion).

The module may also be configured to concurrently handle both networks using dual connectivity, allowing critical data (e.g., messages or voice calls) to be routed via the cellular interface while high-bandwidth software updates are downloaded over WLAN in parallel. In yet another embodiment, the module 102 may create a mobile hotspot within the vehicle for passenger device connectivity, while enforcing data usage policies based on available backhaul bandwidth and vehicle-defined prioritization rules.

These embodiments collectively enable robust, flexible, and intelligent connectivity management that underpins the network prioritization and deferred execution features described in the present disclosure. Other configurations exist and are within the scope of the system described above.

The network selection engine 104 may be communicatively coupled to the wireless communication module 102 and is configured to perform a multi-factor evaluation of available network connections to determine the optimal path for transmitting data associated with one or more software functions. Specifically, the engine 104 may detect the availability and quality of one or more network connections, such as WLAN 110, cellular via base station 108, or other short-range communication protocols (e.g., Bluetooth, UWB), and evaluates at least the following parameters: (i) historical data usage patterns and (ii) the data size associated with the requested software functions, including but not limited to over-the-air (OTA) firmware updates, media content, map data updates, diagnostic logs, and telemetry uploads.

In one embodiment, the network selection engine 104 may prioritize networks based on static thresholds (e.g., updates larger than 100 MB may require Wi-Fi), while in another embodiment, it implements adaptive thresholds learned from user behavior and network performance over time. For instance, the engine 104 may determine that a particular vehicle typically parks within range of a trusted WLAN between 10 PM and 6 AM, and therefore schedules non-critical downloads during that period.

In another embodiment, the engine 104 may incorporate a machine learning model trained using features such as time of day, vehicle location, historical success rates of previous downloads, signal strength metrics, and battery status to predict future network availability and assign confidence scores to each network interface. These scores are then used to select the most likely successful and efficient network path.

In some embodiments, the network selection engine 104 supports user-profile-based logic, where prioritization behavior differs based on the active driver profile or passenger preferences. For example, a fleet vehicle in commercial use may be configured to never use cellular data for updates, while a private vehicle may allow cellular-based downloads when Wi-Fi is unavailable and the data size is below a configurable threshold.

The engine 104 may also account for real-time vehicle context such as speed, ignition state, or energy mode. For instance, data transmission over WLAN may be delayed until the vehicle is stationary or parked in a garage, or blocked entirely during low battery conditions to conserve energy. In another embodiment, the network selection engine 104 interfaces with a calendar or route prediction service to defer downloads until the vehicle is likely to be at a known location with strong WLAN coverage (e.g., home or dealership).

The engine 104 may further support segmented transmission, wherein portions of a data package are transmitted via the available network and the remaining portions are downloaded later when a higher-priority connection becomes available. For example, a software update may begin downloading over a cellular network with a limited cap (e.g., the first 25 MB), with the remaining content scheduled for retrieval once WLAN becomes accessible. The segmented download may be checkpointed to prevent data loss.

In certain embodiments, the engine 104 may include a policy engine that receives and enforces predefined network usage rules. These rules may be defined by OEM administrators, dealerships, or regulators and stored in secure memory. The engine 104 may evaluate policies such as “Do not use cellular when roaming,” “Restrict media streaming while moving,” or “Permit critical updates over any network.”

Finally, the network selection engine 104 may also include a diagnostic and logging subsystem, which tracks failed download attempts, records average download time per network type, and issues alerts or user notifications when a required preferred network is unavailable for an extended period. This functionality supports troubleshooting and helps optimize network performance over time.

The controller 106, which may include a microprocessor, microcontroller, application-specific integrated circuit (ASIC), field-programmable gate array (FPGA), or a dedicated logic circuit, is communicatively coupled to the network selection engine 104 and receives prioritization output therefrom. The controller 106 may be configured to evaluate whether one or more software functions—such as firmware downloads, infotainment system updates, map refreshes, or third-party app synchronizations—should be executed, deferred, or conditionally queued based on the prioritized network connection. For instance, if the network selection engine 104 determines that WLAN 110 is the preferred interface for a large infotainment update and WLAN is unavailable, the controller 106 may temporarily suspend the download request, display a deferral notification to the user, and schedule an automatic retry upon re-establishment of the WLAN connection.

In one embodiment, the controller 106 may maintain a dynamic queue of software function requests, categorized by criticality, data size, and time sensitivity. Low-priority updates may remain in a dormant state, whereas urgent updates may trigger an override, as described below. The controller may apply retry logic that includes randomized backoff intervals, time-window constraints, or contextual triggers (e.g., vehicle parked, ignition off, or charging active).

In some embodiments, the controller 106 may override user-configured network preferences in the case of critical software events, such as updates affecting vehicle systems (e.g., ADAS modules), cybersecurity patches, or compliance-mandated firmware rollouts. For example, if a recall requires an immediate OTA patch, the controller 106 may initiate the download over a cellular connection regardless of user policies that typically prohibit such use.

The controller 106 may include a priority classification engine that cross-references incoming update metadata with a set of predefined risk levels. In one embodiment, critical functions are tagged as "Class A" and may trigger overrides; "Class B" features (e.g., driver comfort systems) follow normal prioritization; and "Class C" items (e.g., cosmetic updates or media downloads) are restricted to WLAN-only operation.

The controller 106 may also interface with a vehicle user interface (UI)—such as a touchscreen, instrument cluster, or companion mobile app—not shown in FIG. 1. Through the UI, users may customize network preferences, set download time restrictions, or define data caps per connection type. In some embodiments, users may assign feature-specific rules, such as: "Map data may be downloaded via cellular if smaller than 25 MB," or "Block all video streaming until connected to home Wi-Fi."

In another embodiment, the controller 106 may support multi-user profile management, wherein different occupants (e.g., driver vs. passenger) may maintain individualized network settings. The controller 106 may retrieve and enforce these settings upon profile authentication, such as via key fob, mobile device pairing, or biometric input.

In fleet vehicle scenarios, the controller 106 may be configured to operate in administrator-locked mode, where driver-defined preferences are overridden by enterprise-level policies. These policies may be remotely provisioned by a fleet management server and may include bandwidth throttling, off-peak-only data usage, or predefined update windows.

The controller 106 may also include a policy enforcement engine that ensures conformance with data governance rules and regulatory constraints. For example, in regions with roaming restrictions or limited 4G coverage, the controller may prohibit updates over certain networks altogether.

In advanced embodiments, the controller 106 further supports event-driven behavior, such as triggering the execution of deferred software functions upon detection of favorable vehicle states—e.g., engine off, parking brake engaged, or high-voltage battery at >60% state-of-charge. This enables updates to be completed without compromising user experience or power efficiency.

The WLAN 110 may be provided by a static access point (e.g., home Wi-Fi, dealership hotspot) or a mobile hotspot, such as a smartphone or dedicated vehicle device. The base station 108 may represent any node in a cellular communication infrastructure, supporting technologies such as LTE, 5G NR, or equivalent.

The arrows shown between components in FIG. 1 indicate communication and/or control signaling between functional blocks. For example, bidirectional arrows between the wireless communication module 102 and the controller 106 represent both the provision of real-time connection status and the receipt of execution commands for data transfers.

This modular architecture allows flexible implementation of the disclosure across various vehicle platforms, and supports dynamic data flow decisions that reduce cellular data consumption, enhance bandwidth efficiency, and ensure delivery of important software functions through optimal network paths.

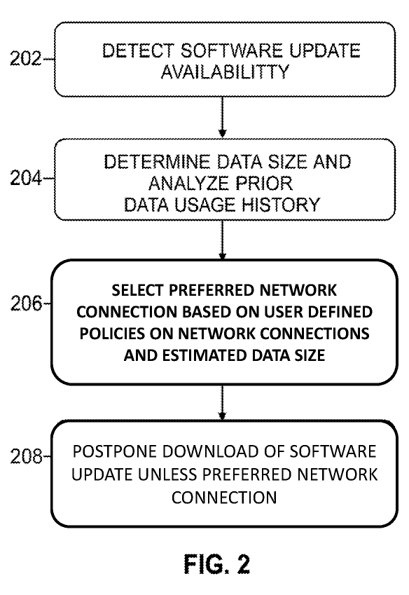

FIG. 2 is a flowchart illustrating a method for managing OTA software updates using dynamic network prioritization based on update size, data size, network conditions, and user-defined preferences, in accordance with one or more embodiments. This method may be implemented in an embedded system such as a vehicle head unit, infotainment controller, or mobile device. The logic of each block may be carried out by a processor configured to execute program instructions stored in memory, and may optionally interact with network interfaces, user profiles, or cloud services.

At block 202, the system may detect the availability of a software update. In one embodiment, the system periodically polls a remote update server, such as every 24 hours or once per ignition cycle. In another embodiment, the system receives a push notification when an update becomes available, allowing more efficient use of bandwidth and power. In some cases, the system triggers an update check based on an event, such as vehicle start-up, connection to a known Wi-Fi network (e.g., home or dealership), or completion of a prior update.

In yet another embodiment, update availability may be determined based on the user’s region, subscription plan, or vehicle configuration profile. For example, only vehicles in a specific geographic area or using a particular software branch may be eligible for an update at a given time. Update eligibility logic can be customized by the original equipment manufacturer (OEM).

At block 204, the system may calculate the expected data size associated with the software update and analyzes prior data usage history. In a basic embodiment, the system extracts update size information from metadata received from the update server (e.g., total number of bytes, number of files, version delta).

In some embodiments, the system may include real-time data usage in the estimation. For example, if the update requires decompression, verification, streaming of encrypted components, or telemetry uploads during execution, the system dynamically monitors these activities and includes the additional bandwidth consumption in the effective data size estimate.

The system may further monitor concurrent bandwidth usage by other applications executing on the platform (e.g., music streaming, navigation downloads, telemetry transmission), particularly during the projected update window. These factors are integrated into a runtime-aware total data cost, which better reflects the actual load placed on the network.

In another embodiment, the system references historical data logs to analyze trends in network usage across network types (e.g., cellular vs. Wi-Fi). Such analysis may include: cumulative usage over past billing cycles; average download sizes; frequency of software updates; and data usage per update session. This historical profile allows the system to make more intelligent decisions in future network selections and comply with user data plans or policy thresholds.

In an advanced configuration, the system aggregates data usage forecasts for multiple scheduled operations—including application updates, map downloads, or diagnostics—into a unified bandwidth projection model. This model may use learned parameters from previous update behaviors to better anticipate spikes in data usage.

At block 206, the system may select a preferred network for the download based on user-defined policies and contextual data such as current network performance and estimated data size from block 204. In one embodiment, the user may define preferences such as: "Use only Wi-Fi for updates over 100 MB."; "Avoid cellular downloads when roaming."; and "Download only when signal strength exceeds a defined threshold.". The policy engine may be preloaded by the OEM and/or customized by the user through an interface. These policies are stored locally or retrieved from the cloud.

In another embodiment, the system dynamically compares the cost, latency, and reliability of available network interfaces (e.g., Wi-Fi, LTE, 5G, satellite) and selects the most efficient connection based on present conditions. For example, the system may select Wi-Fi if the signal is strong and stable, or delay selection if networks appear congested or unreliable.

In a more advanced implementation, the system integrates contextual awareness—taking into account factors such as vehicle speed, location, time of day, and historical download success. For instance, if the vehicle is moving through a tunnel, the system may avoid initiating the update. Or, if the download historically succeeds faster when the vehicle is stationary at home, it may postpone selection until such conditions are met.

Optionally, a reinforcement learning algorithm may be applied to refine the decision model over time, incorporating user overrides, completion success rates, and network behavior.

At block 208, the system determines whether to proceed with the software update or postpone it, depending on the current network availability relative to the preferred connection selected in block 206. In one embodiment, if the preferred network is unavailable, the system enters a passive monitoring state and reattempts download when conditions improve. For example, it may wait for the vehicle to reconnect to a trusted Wi-Fi network before initiating download.

In another embodiment, the system supports opportunistic downloading, immediately initiating the update if the preferred network becomes temporarily available (e.g., while idling in a parking structure with Wi-Fi access). In configurations that prioritize user input, the system may prompt the user to manually approve proceeding with a non-preferred connection. The user may choose to: authorize the download despite policy; delay the operation to a later time; and change network preferences.

A further embodiment includes partial download logic, where small or critical portions of the update (e.g., update metadata or install pre-checks) may be downloaded over an available network while deferring larger components until optimal connectivity is restored.

In scenarios where the update is critical or time-sensitive, the system may engage a degraded mode: using data compression, prioritizing only essential update modules, or proceeding over a lower-priority network after predefined postponement intervals.

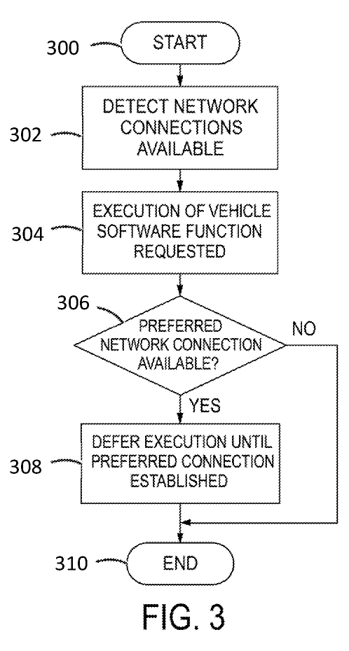

FIG. 3 is a flowchart illustrating the operation of the controller in deferring vehicle software functions until a preferred network connection is available, in accordance with one or more embodiments. This method may be implemented by one or more processors within a vehicle's ECUs, including but not limited to the telematics control unit, infotainment system, or gateway module. The method enables intelligent deferral of certain network-reliant functions until an optimal or user-preferred network is available, thereby reducing costs, preserving quality of service, or complying with data usage policies.

The process may begin at block 300. This initialization may occur automatically upon vehicle startup, engine-on events, power cycling of a connectivity module, or based on a periodic schedule. In some embodiments, the initiation may be event-driven, such as when a system receives a remote command from a backend server or a user manually initiates a network-reliant function.

At block 302, the system may detect one or more available network connections. These may include wireless local area network (WLAN), cellular networks (e.g., LTE, 5G), satellite, Bluetooth tethering, or vehicle-to-everything (V2X) interfaces. In one embodiment, the system may sequentially scan all available interfaces and compiles a list of active network connections, optionally ranking them based on signal strength, latency, and historical performance. In another embodiment, the system listens for OS-level or firmware-level notifications indicating that a network interface has become active or inactive, allowing efficient and low-power monitoring. The system may further query network identifiers (e.g., SSID, carrier profile) to determine network type, cost status, roaming condition, and historical reliability.

At block 304, the system may receive a request to execute a vehicle software function that requires network connectivity. This request may originate from a variety of sources, including a user interface command, scheduled background tasks, remote server instructions, or internal subsystem triggers.

The software function may include, but is not limited to: downloading or installing software or firmware updates; uploading vehicle logs or diagnostic reports; synchronizing multimedia or navigation data; and performing remote control tasks or analytics.

In one embodiment, the function is initiated by a user through an HMI touchscreen or voice command. In another embodiment, the task is scheduled to occur periodically or in response to specific vehicle events (e.g., engine shutoff or battery fully charged). Certain functions may be conditionally queued based on vehicle state, driver profile, or battery health.

At decision block 306, the system may determine whether a preferred network connection is currently available. The preferred connection may be defined by system-level configuration, user preferences, policy constraints, or adaptive logic based on cost, speed, and reliability.

In one embodiment, the preferred network is specified in a user-defined profile—for example, updates may be allowed only over Wi-Fi or only when tethered to a known mobile hotspot. In another embodiment, the system dynamically selects a preferred network based on metrics such as signal quality, estimated download time, or remaining cellular data quota. In yet another embodiment, the function being requested may have an associated priority level, such that high-priority tasks override normal preferences and proceed over any available connection.

If the preferred network is not currently available, the system proceeds to block 308 to defer execution. If the preferred network is available, the function proceeds immediately or is handled by a separate execution module.

At block 308, if the preferred network is not available, the system may defer the execution of the requested function. During this deferred state, the system may periodically recheck for network availability or listen for network state change notifications.

In some embodiments, the system enters a passive monitoring state with power-saving features enabled, awaiting a transition to the preferred network. In other embodiments, the system may retry availability checks using a defined retry interval or based on predictive models that estimate when the preferred network is likely to become available (e.g., based on past behavior such as the vehicle returning to a home Wi-Fi zone in the evening).

Optionally, the system may perform non-network-dependent parts of the function in advance. For example, it may prepare file validation checks or user prompts while awaiting suitable network conditions. This allows seamless continuation once the preferred connection is established.

At block 310, the process ends. This may occur after successfully deferring and then executing the function when the preferred network becomes available, or after timing out based on policy thresholds. The system may optionally log the outcome of the deferral process, generate a user-facing notification, or report the status to a backend server for compliance tracking.

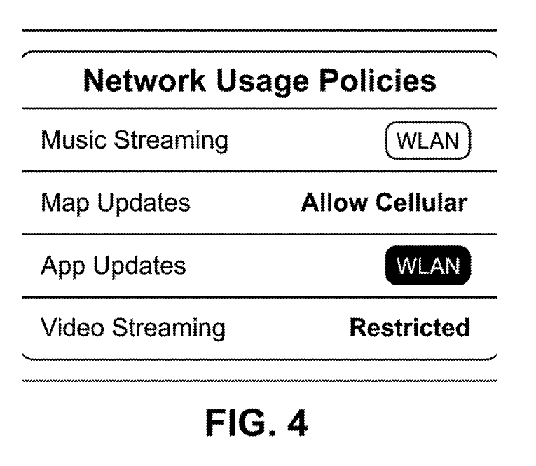

With reference now to FIG. 4, a diagram of a user interface display allowing configuration of network usage policies for specific applications and features, in accordance with one or more embodiments, is provided. This policy configuration may be presented in the form of a graphical user interface (GUI), a configurable preferences menu, or a system-managed ruleset. The policy structure enables selective control over which types of network connections (e.g., WLAN, cellular) may be used for distinct application functions, thereby improving user control, reducing data costs, and ensuring appropriate quality of service.

In the illustrated embodiment, FIG. 4 includes four application categories, each associated with a defined network usage policy. These application types may correspond to common in-vehicle connected functions such as entertainment, navigation, application maintenance, and media services. The policies define whether a function is allowed to operate over a given network type or is subject to restrictions.

For the Music Streaming application, the policy is set to “WLAN”, indicating that music playback requiring data connectivity is permitted only over a wireless local area network. In one embodiment, this may correspond to onboard Wi-Fi provided by an external access point or tethered mobile hotspot. If WLAN is not available, streaming may be disabled, suspended, or replaced with locally cached content. The restriction helps users minimize cellular data consumption and optimize audio quality when on high-bandwidth connections.

The Map Updates function is associated with the policy “Allow Cellular”, indicating that updates to navigation data may occur over either WLAN or cellular connections. In some embodiments, the system evaluates additional factors such as roaming status, data plan limitations, and connection quality before initiating downloads over cellular. This setting reflects a balance between data availability and usability, allowing time-sensitive updates even when WLAN is unavailable.

For App Updates, the network policy is also “WLAN”, signifying that the system is configured to perform updates of installed applications only when a WLAN connection is present. This policy reduces the likelihood of incurring large data usage over mobile networks. In alternative implementations, app updates may be queued for deferred execution or partially preloaded with finalization deferred until WLAN connectivity is restored.

The Video Streaming function is governed by the policy “Restricted”, indicating that access to streaming video content is limited or entirely prohibited. In one embodiment, this restriction may be enforced universally regardless of network type to preserve bandwidth or enhance safety by reducing driver distraction. In another embodiment, restrictions may be lifted conditionally—such as when the vehicle is stationary, in park, or when a rear-seat passenger is detected via in-cabin sensing.

The data structure may be stored locally in non-volatile memory or synchronized with a backend server for fleet or multi-vehicle use cases. In various embodiments, the network usage policies may be implemented via:
A user-facing configuration interface, where vehicle occupants can set or modify policies for each application or service;
OEM-defined presets, established at the factory or dealership level, with limited or no user override capability for fleet or parental control use cases;
Adaptive system rules, wherein policies are modified dynamically based on historical behavior, time of day, location, or user profile;
Cloud-synchronized profiles, enabling policy transfer across multiple vehicles linked to the same user account or profile; and
Policy enforcement logging, which tracks when and how network policies are enforced or bypassed, supporting audit, diagnostics, or regulatory compliance.

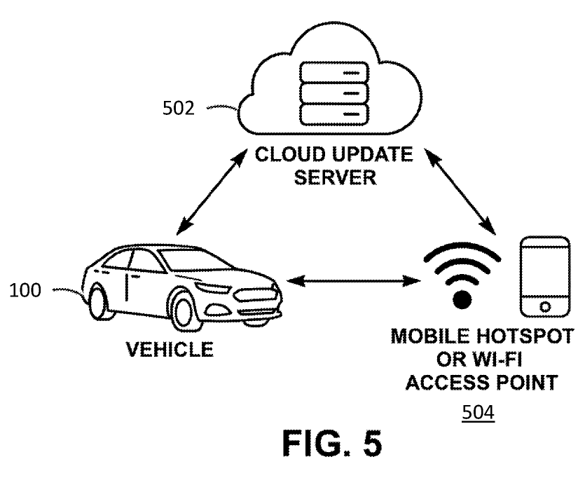

FIG. 5 is a schematic view illustrating interaction between the vehicle 100, a cloud update server 502, and a mobile hotspot or Wi-Fi access point 504 for managing data transmission, in accordance with one or more embodiments. This system facilitates wireless delivery of software updates, telematics data, and other digital content to the vehicle.

In one embodiment, the vehicle 100 may be configured with an onboard communications module (e.g., a telematics control unit or embedded wireless modem) capable of establishing a connection with a nearby wireless local area network (WLAN), such as a mobile hotspot or a residential/commercial Wi-Fi access point 504. Once connected, the vehicle may initiate a data session with a cloud update server 502 hosted on a remote network.

The cloud update server 502 is configured to transmit digital payloads such as: firmware-over-the-air (FOTA) updates for vehicle ECUs; infotainment software patches, navigation map data, user preference profiles; and vehicle usage analytics data. Upon successful connection, the vehicle may authenticate with the cloud update server and request applicable updates based on its current software configuration and vehicle identification information.

In another embodiment, the Wi-Fi access point 504 may be a mobile hotspot provided by a user device, such as a smartphone. The mobile device may serve as an intermediary communication bridge between the vehicle and the internet. The vehicle may automatically recognize and connect to a previously-paired device hotspot (e.g., via Bluetooth or saved SSID credentials) and initiate a secure connection to the cloud update server. This configuration may be particularly useful in scenarios where fixed wireless infrastructure is unavailable, such as in rural or temporary parking environments.

In a further embodiment, the vehicle includes logic for network prioritization and enabling it to opportunistically select among multiple available wireless networks. This prioritization may be based on: network signal strength; cost profiles (e.g., avoiding cellular data overages); security level (e.g., WPA3 vs open networks); and historical reliability.

The system may include a network selection engine that determines whether to use the vehicle’s built-in LTE modem or connect via WLAN access point 504. Based on this decision, update requests may be dynamically routed to the cloud server 502 through the selected network path.

Once a communication session is established, the vehicle may transmit a software configuration report to the cloud update server. The server may identify delta files or compressed updates applicable to the vehicle’s current version. A secure download stream may be initiated using encrypted communication protocols (e.g., TLS). Optionally, the vehicle may upload diagnostic data or usage logs to the cloud server for analytics or predictive maintenance.

In some embodiments, the cloud server may initiate push-based notifications indicating the availability of updates, which the vehicle polls periodically or on ignition. The disclosed system provides several advantages, including:
Advantageously, the system provides reduced dependency on cellular data networks and faster update downloads using high-bandwidth local networks. The system may also provide flexible and user-friendly update scheduling as well as enhanced user control over data costs and timing.

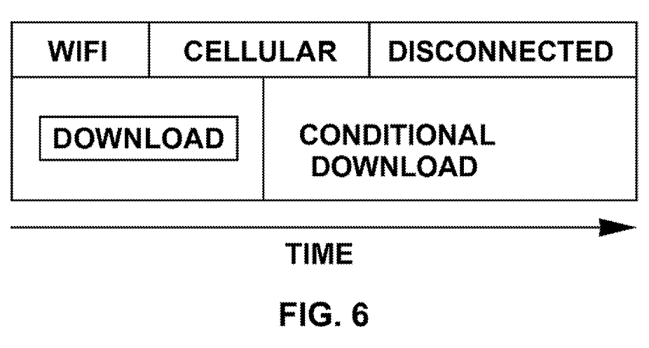

FIG. 6 is a diagram showing an example of network switching behavior and conditional download execution across multiple connectivity states (Wi-Fi, cellular, disconnected), in accordance with one or more embodiments. The system is designed to optimize download behavior based on network connectivity conditions over time, such as the presence or absence of Wi-Fi, cellular, or no network access at all. The horizontal axis represents the passage of time, while the vertical blocks depict the type of network connectivity available at any given time—namely, Wi-Fi, Cellular, and Disconnected. Superimposed on the connectivity states are indicators of corresponding download policies applied by the system under each condition.

In a first segment of the timeline, when the vehicle is connected to a Wi-Fi network, the system enters a DOWNLOAD state. In this state, data such as firmware updates, navigation content, infotainment packages, or software patches are downloaded automatically and without restriction. Wi-Fi connectivity is treated as the preferred and cost-effective option for data transfer, particularly when the network is authenticated and secure. The download is initiated unconditionally upon verification of Wi-Fi availability.

As the vehicle transitions into a Cellular connectivity state, the system may remain in the DOWNLOAD state temporarily, depending on policy settings. However, in one embodiment, the system shifts into a Conditional Download state, where the decision to continue or initiate a download is governed by one or more criteria. These criteria may include: (1) file size thresholds (e.g., only allow downloads under 10 MB), (2) user-defined settings (e.g., allow updates only over Wi-Fi), (3) carrier data plan usage, (4) signal strength and quality, and (5) roaming status. The system may consult a download policy engine, which evaluates whether the conditions are met. If conditions are not met, the download is suspended or deferred.

In the final segment of the timeline, the vehicle enters a Disconnected state, meaning it lacks any form of network connectivity. During this phase, the system also enters the Conditional Download state, in which downloads are neither initiated nor continued. Instead, the system queues the update tasks internally and enters a wait state. The system periodically scans for reconnection opportunities, either passively (e.g., via scheduled polling) or actively (e.g., triggered by vehicle ignition or geographic geofencing events). Once a preferred network becomes available, the system re-evaluates the conditions and resumes the pending download accordingly.

In one embodiment, the system may define a hierarchy such that Wi-Fi networks are preferred over cellular networks, and cellular networks are preferred over disconnection. Within the cellular category, the system may further distinguish between 4G, 5G, or roaming conditions.

In another embodiment, update files may be classified into different tiers such as "Critical" (e.g., safety patches), "Standard" (e.g., firmware enhancements), and "Optional" (e.g., media files), each tier having unique download permissions per network type.

The vehicle interface may allow users to configure their preferences for download behaviors—for instance, enabling downloads only when the vehicle is parked and connected to a trusted Wi-Fi network. A graphical user interface may provided to facilitate such preferences.

In certain implementations, the system may use historical data (e.g., prior connection times and locations) to predict when favorable network conditions will be available and proactively schedules the download for that window.

Security and resumption support may be given. All downloads may be encrypted and include integrity verification using cryptographic signatures. Downloads interrupted due to network state transitions may be resumed from the point of interruption using checksum-based validation.

In fleet or enterprise settings, remote management systems may push policy updates to vehicles to enforce data usage rules, restrict downloads to specific geolocations, or perform staggered rollouts of firmware.

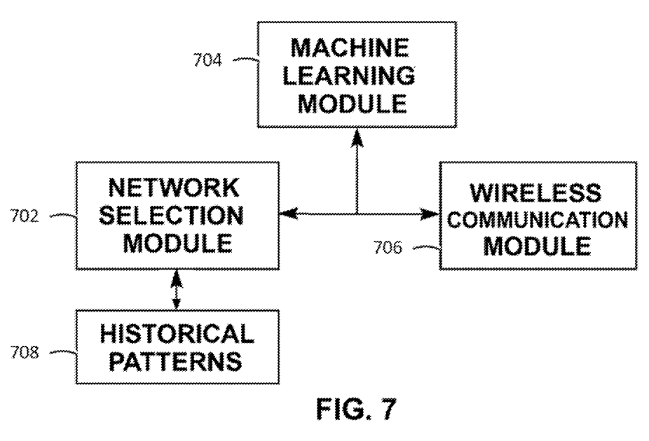

FIG. 7 is a block diagram illustrating integration of a machine learning module within the network selection engine to optimize future download scheduling based on historical patterns, in accordance with one or more embodiments. The system optimizes selection of a wireless communication channel for data transfer operations, such as downloading software updates, by leveraging learned behavior and real-time network conditions. The shown components may be implemented as hardware, software, firmware, or any combination thereof, and may reside partially or entirely within a telematics control unit or central vehicle computing system.

The Network Selection Module 702 may be configured to determine, based on current and historical network conditions, which communication channel to utilize for data transmission. The module receives inputs from both the Wireless Communication Module 706 and the Historical Patterns Module 708, and applies logic to select a preferred network interface (e.g., Wi-Fi, cellular, or other) based on predefined or dynamically learned criteria.

Selection criteria may include, but are not limited to: available bandwidth, network signal strength, connection stability, cost metrics (e.g., cellular data charges), user-configured preferences, or the type and urgency of the data to be transmitted.

The Machine Learning Module 704 is operably coupled to the Network Selection Module 702 and is configured to enhance the accuracy and adaptability of network selection decisions over time. The Machine Learning Module 704 may be trained using supervised, unsupervised, or reinforcement learning techniques, and may generate predictive models based on input from the Historical Patterns Module 708. These models may be used to forecast optimal download windows or anticipate failure-prone connectivity scenarios.

For example, the Machine Learning Module 704 may determine that the vehicle consistently connects to a reliable Wi-Fi network at a particular location and time of day. This learned behavior can then be used to schedule deferred downloads or adjust prioritization rules within the Network Selection Module 702.

The Wireless Communication Module 706 may manage the physical and logical interfaces to one or more network access points. These may include Wi-Fi interfaces, cellular modems (e.g., 3G, 4G, 5G), and other wireless protocols such as DSRC or Bluetooth. The module monitors real-time connection status, signal strength, throughput, and connection latency, and provides this information to the Network Selection Module 702 for analysis.

The Wireless Communication Module 706 may also be responsible for executing network transitions as instructed by the Network Selection Module 702, and for initiating or resuming data transfers when conditions are deemed acceptable.

The Historical Patterns Module 708 may store data related to past connectivity events and download performance. The stored data may include: network types and signal quality available at specific geographic coordinates; temporal patterns of successful or failed downloads; user behavior, such as manual connection overrides or device tethering frequency; and metrics on data transfer rates and latency across different network conditions.

This historical data is used both by the Network Selection Module 702 for rule-based decision-making, and by the Machine Learning Module 704 for pattern recognition and predictive modeling. In one embodiment, the system may utilize learned behavioral patterns to anticipate optimal times and locations for data downloads. For instance, if the Historical Patterns Module 708 indicates that a stable Wi-Fi connection is typically available when the vehicle is parked at the user’s residence between 6:00 PM and 7:00 PM, the Network Selection Module 702 may defer non-urgent downloads until that window, thereby avoiding use of metered cellular data.

In another embodiment, the Machine Learning Module 704 may identify that certain public Wi-Fi hotspots consistently yield poor download performance, and adjusts the network priority model accordingly to deprioritize those networks for future updates. In yet another embodiment, the system supports dynamic adaptation: if a previously reliable network becomes unstable, the system may adjust its confidence level or threshold parameters without manual input.

The architecture shown in FIG. 7 may provide several advantages: adaptive intelligence that improves download decisions over time without user intervention; predictive scheduling based on real-world usage patterns; bandwidth and cost optimization by deferring downloads to preferred networks; and robustness against poor network conditions through proactive learning and failover strategies.

It should be understood that the term “module” is intended to encompass a structure that may be physically distributed across multiple devices or subsystems but functions as a logical unit for performing a described function. The components of a module may communicate through various interconnection technologies, including wired or wireless buses, networks, or internal communication protocols. Unless explicitly stated otherwise, the term “module” should not be limited to any specific implementation or arrangement.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean "one and only one" unless specifically stated, but rather "one or more." All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A data management system, comprising:
a wireless communication module configured to communicate over a cellular network and a wireless local area network (WLAN);
a network selection engine detecting availability of one or more network connections, evaluating historical data usage and data size of one or more software functions, and dynamically prioritizing a use of the WLAN and cellular network for data transmission of the one or more software functions based on the evaluation; and
a controller deferring execution of the one or more software functions until a preferred network connection is established based on the prioritization.

2. The data management system of claim 1, wherein the network selection engine includes a machine learning model trained to identify optimal download windows based on past usage patterns and network reliability.

3. The data management system of claim 1, wherein the controller overrides user-defined policies in the event of a critical update.

4. The data management system of claim 1, wherein the controller restricts activation of a driver assistance function until a required software component is downloaded via the preferred network.

5. The data management system of claim 1, further comprising a user interface for customizing network preferences for specific applications or systems.

6. The data management system of claim 1, wherein the network selection engine performs periodic pings to evaluate Wi-Fi quality before initiating data transfer.

7. The data management system of claim 1, further comprising an application-specific data policy manager that blocks high-bandwidth features from launching until preferred connectivity is detected.

8. A method for managing over-the-air software updates comprising:
detecting a software update available for download;
determining a size of the software update and analyzing prior data usage history;
selecting a preferred network connection from among a set of available networks based on:
user-defined policies;
real-time network conditions;
the determined update size; and
postponing the download of the software update unless the preferred network connection is available.

9. The method of claim 8, wherein the user-defined policies comprise thresholds for update sizes, types of permissible networks, and timing of allowable downloads.

10. The method of claim 8, further comprising detecting user presence in a vehicle and scheduling the update during inactive vehicle operation hours.

11. The method of claim 8, wherein the available networks include Wi-Fi, Ethernet, and mobile hotspots initiated via a companion mobile device.

12. The method of claim 8, wherein the software update is segmented into critical and non-critical modules and downloaded using different network criteria.

13. The method of claim 8, further comprising determining whether the software update pertains to essential vehicle functions and proceeding with cellular download if critical.

14. The method of claim 8, wherein the postponement of download includes a retry schedule based on periodic availability checks for the preferred network.

15. The method of claim 8, wherein a partial download is allowed over cellular with the remainder completed via WLAN when it becomes available.

16. A computer-readable storage medium having instructions stored thereon that, when executed by a processor, causes performance of operations comprising:
monitoring for large data download or upload requests initiated by a system;
evaluating whether a non-cellular network connection is currently active;
restricting or suspending such data transfer operations when only cellular data is available; and
enabling the data transfer upon establishment of a non-cellular connection.

17. The computer-readable storage medium of claim 16, wherein the operations further include prompting a user to establish a Wi-Fi connection if none is detected.

18. The computer-readable storage medium of claim 16, wherein the data transfer includes at least one of OTA software updates, media downloads, map data, and telemetry uploads.

19. The computer-readable storage medium of claim 16, wherein restriction of data transmission is subject to user-configurable override through a secure interface.

20. The computer-readable storage medium of claim 16, wherein the operations include storing a history of deferred updates and transmission attempts for diagnostics.
